(19) United States
(12) Patent Application Publication
(10) Pub. No.: US 2014/0156242 A1
(43) Pub. Date: Jun. 5, 2014

(54) METHOD AND SYSTEM FOR AUTOMATED MACHINE DESIGN

(71) Applicant: SOLAR TURBINES INCORPORATED, San Diego, CA (US)

(72) Inventors: Paul R. BULLARA, Carlsbad, CA (US); Doru Catalin DOSIANU, San Diego, CA (US); Jonathan P. WINDT, San Diego, CA (US)

(73) Assignee: SOLAR TURBINES INCORPORATED, San Diego, CA (US)

(21) Appl. No.: 13/691,009

(22) Filed: Nov. 30, 2012

(51) Int. Cl. G06F 17/50

(52) U.S. Cl. CPC G06F 17/5086
USPC 703/7

(57) ABSTRACT

A system for automated machine design is disclosed. The system may have at least one of a part database and a relationship database, a display device, and an input device. The system may also have one or more processors in communication with the at least one of a part database and a relationship database, the display device, and the input device. The processors may be configured to cause a listing of components selectable by a customer for inclusion within a machine to be shown on the display device, and to receive a selection of the components from the listing by the customer via the input device. The processors may also be configured to retrieve data regarding selected components from the at least one of the part database and the relationship database, and to generate a design for at least one new support component in the machine based on the selected components and the data.

### TECHNICAL FIELD

The present disclosure relates generally to a design method and system, and more particularly, to a method and system for automated machine design.

### BACKGROUND

Different customers use machine systems with different component configurations depending on intended applications for the systems. For example, one customer may select a first input component (e.g., an engine) having a particular size, speed, capacity, and/or cost to drive a first output component (e.g., a compressor) having a corresponding size, speed, capacity, and/or cost to achieve a first goal (e.g., efficiency, emissions, fuel consumption, packaging, budgetary, etc.). A second customer, however, may select a second input component to drive the first output component and achieve a second goal, while a third customer may select the first input component to drive a second or third output component to achieve a third goal.

While customization of machine system configurations can be beneficial for the customer, it also creates significant work for the manufacturer of the machine systems. In particular, each machine system configuration can require hundreds or even thousands of hours of engineering work to design support components (e.g., platforms, pedestals, grating, fluid circuitry, etc.) required to interconnect the different components selected by the customer. In some situations, this extra work may be worthwhile, as long as the new system configuration is requested in large number by the customer. In other situations, however, the extra design work may reduce profitability of the new configuration.

### SUMMARY

In one aspect, the present disclosure is directed to a system for automated machine design. The system may include at least one of a part database and a relationship, a display device, and an input device. The system may also include one or more processors in communication with the at least one of a part database and a relationship database, the display device, and the input device. The one or more processors may be configured to cause a listing of components selectable by a customer for inclusion within a machine to be shown on the display device, and to receive a selection of the components from the listing by the customer via the input device. The one or more processors may also be configured to retrieve data regarding selected components from the at least one of the part database and the relationship database, and to generate a design for at least one new support component in the machine based on the selected components and the data.

In another aspect, the present disclosure is directed to a method for automatically designing a machine. The method may include displaying a listing of components selectable by a customer for inclusion within a machine, and receiving a selection of the components from the listing by the customer. The method may also include retrieving data regarding selected components from at least one of a part database and a relationship database, and automatically generating a design for at least one new support component in the machine based on the selected components and the data.

In a further aspect, the present disclosure is directed to a non-transitory computer readable medium for use on at least one computer system containing computer-executable programming instructions for performing a method of automated machine design. The method may include displaying a listing of components selectable by a customer for inclusion within a machine, and receiving a selection of the components from the listing by the customer. The method may further include retrieving a listing of critical dimensions that vary between different components of the listing of components selectable by the customer, and retrieving relationship information regarding how at least one new support component should change based on the listing of critical dimensions. The method may also include automatically generating a design for the at least one new support component in the machine based on the selected components, the critical dimensions, and the relationship information. The method may additionally include disassociating the design for the at least one new support component from a generic template used to generate the design, assigning a unique identifier to the design, and saving the design. The method may also include rendering the design for the at least one new support component within a computer aided drafting environment.

### BRIEF DESCRIPTION OF THE DRAWINGS

FIG. 1 is a perspective view illustration of an exemplary disclosed machine;

FIG. 2 is a diagrammatic illustration of an exemplary disclosed design system that may be used to automatically design the machine of FIG. 1;

FIGS. 3-5 are pictorial illustrations of exemplary disclosed components of the machine illustrated in FIG. 1; and

FIG. 6 is a flowchart depicting an exemplary disclosed method implemented by the design system of FIG. 2.

### DETAILED DESCRIPTION

The disclosed methods and systems are explained below in relation to a specific machine having input and output modules. The input and output modules are shown and described as being gas turbine and compressor modules, respectively. It should be noted, however, that other and different modules and/or machines may similarly be designed with the disclosed methods and systems, if desired. Accordingly, the machine, input module, and output modules should be considered exemplary only.

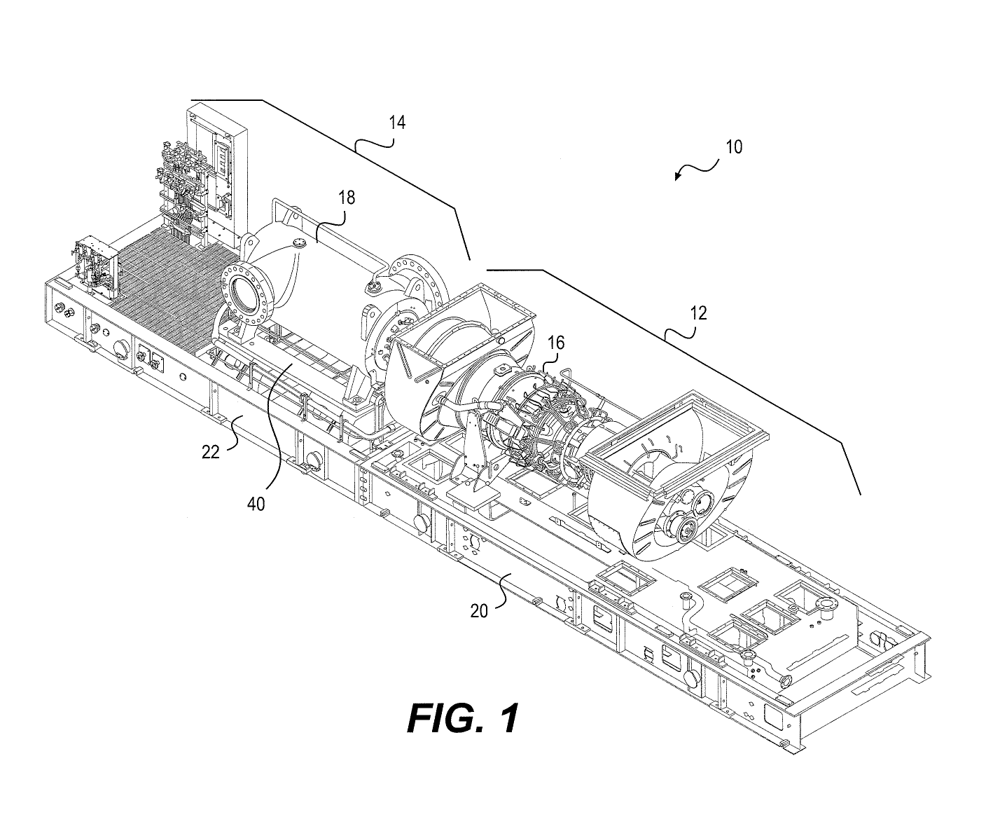

FIG. 1 illustrates an exemplary machine 10 having an input component 12 operatively coupled to an output component 14. In the disclosed embodiment, machine 10 is a gas turbine-powered compressor system. In this embodiment, input component 12 is a gas turbine module and output component 14 is a compressor module connectable to be driven by the gas turbine module. As a gas turbine module, input component 12 includes a gas turbine engine 16 that is configured to receive a mixture of air and fuel, combust the mixture, and produce a mechanical output rotation. The mechanical output rotation is then directed to the compressor module to drive a compressor 18 of the module and compress a gas. The gas may include, for example, air, natural gas, or another gas known in the art.

Engine 16 of the gas turbine module may be mounted to a platform 20, and the gas turbine module may further include all support components necessary to run the engine. For example, the gas turbine module may include all the hardware required to mechanically connect engine 16 to platform 20. The gas turbine module may also include components associated with a fuel system, an air induction system, an exhaust system, a lubrication system, a cooling system, a control system, etc. The gas turbine module may be configured to be easily transportable and connectable to a variety of different compressor modules. It is contemplated that the gas turbine module may be packaged and sold independent of the compressor module, or alternatively packaged and sold together with the compressor module as a single machine 10.

The depicted gas turbine module may be representative of a variety of available modules that are selectable by a customer for inclusion within a particular machine 10. For example, the customer may be able to select for packaging and purchasing any number of gas turbine modules that differ in a variety of ways. The different gas turbine modules may range in size, speed, power, emissions, noise, fuel, cost, and/or in other ways known in the art. Each gas turbine module may include a different gas turbine engine 16, a different platform 20, a different fuel system, a different air system, a different lubrication system, a different exhaust system, a different cooling system, and/or different hardware that connects the components of the module together.

Compressor 18 of the compressor module may also be mounted to a platform 22, and the module may further include all support components necessary to facilitate operation of compressor 18. For example, the compressor module may include all the hardware required to mechanically connect compressor 18 to platform 22. The compressor module may also include components associated with a gas induction system, a gas discharge system, a lubrication system, a cooling system, a control system, etc. The compressor module may be configured to be easily transportable and connectable to variety of different gas turbine modules. It is contemplated that the compressor module may be packaged and sold independent of the gas turbine module, or alternatively packaged and sold together with the gas turbine module as a single machine.

The depicted compressor module may be representative of a variety of available compressor modules that are selectable by the customer for inclusion within a particular machine 10. For example, the customer may select for packaging and purchasing any number of compressor modules that differ in a variety of ways. The different compressor modules may range in size, speed, power, noise, cost, and in other ways known in the art. Each compressor module may include a different compressor 18, a different platform 22, a different lubrication system, a different cooling system, a different induction system, a different discharge system, and/or different hardware that connects the components of the module together.

In some applications, the customer may be able to select any existing gas turbine module for connection to any existing compressor module. In other applications, the customer may be able to select particular components within one or both of the gas turbine and compressor modules. For example, the customer may be able to select a particular gas turbine engine 16, a particular compressor 18, a particular fuel system, a particular platform 20, 22, or another particular component or system within one or both of the gas turbine and compressor modules. In some situations, the configuration of components selected by the customer may have already been designed and compiled within an existing module and, thus, ready for manufacture. In other situations, however, the configuration of components selected by the customer may be new. In these situations, design work may be required before the gas turbine and/or compressor modules are made available for purchase by the customer.

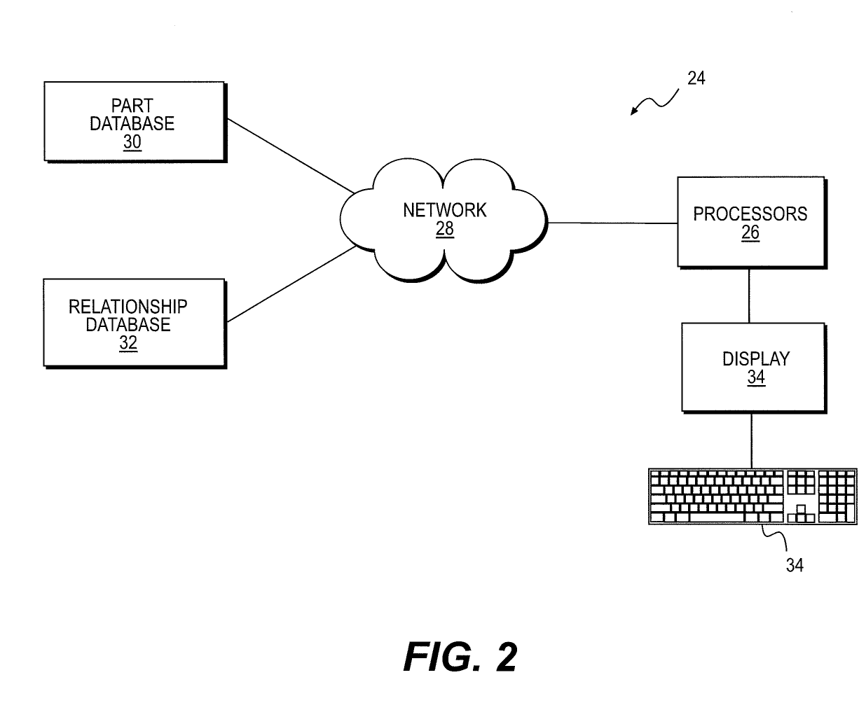

FIG. 2, illustrates an exemplary disclosed system 24 used to automatically generate designs for the gas turbine and/or compressor modules having new configurations selected by the customer. System 24 may include one or more computer processors (or other hardware) 26 and software applications (or other software) executable by processor(s) 26 to perform certain functions related to module design. These functions may include, but are not limited to, generating, maintaining, updating, deleting, rendering, analyzing, and/or presenting different design configurations of machine 10 (referring to FIG. 1).

Processor(s) 26 may be connected, e.g., via a network 28, to one or more databases. These data bases may include, among others, a part database 30 that contains dimensional information regarding the different components within each of the gas turbine and compressor modules that are selectable by the customer, and a relationship database 32 that contains information relating changes in particular components to changes in other support components within the same machine 10. Network 28 may be any type of wired or wireless communication network for exchanging or delivering information or signals, such as the internet, a wireless local area network (LAN), or any other network. Thus, network 28 may be any type of communications system known in the art.

Processor(s) 26 may have an integral memory or otherwise be connected to an external memory (not shown), a transceiver device (not shown), and a display device 34. Display device 34 may include one or more monitors (e.g., a liquid crystal display (LCD), a cathode ray tube (CRT), a personal digital assistant (PDA), a plasma display, a touch-screen, a portable hand-held device, or any such display device known in the art) configured to actively and responsively display information to a user of system 24, such as a designer, the customer, or any other entity.

The transceiver device may include one or more devices that transmit and receive data, such as data processed by processor(s) 26 and/or stored by the memory. The memory may be configured to store information used by processor(s) 26, e.g., computer programs or code used by processor(s) 26 to enable processor(s) 26 to perform functions consistent with this disclosure. The memory may include one or more memory devices including, but not limited to, a storage medium such as a read-only memory (ROM), a flash memory, a dynamic or static random access memory (RAM), a hard disk device, an optical disk device, etc.

Processor(s) 26 may be configured to receive data (e.g., from the databases listed above) and/or from a customer or user, and responsively process information stored in the memory. Processor(s) 26 may be configured with different types of hardware and/or software (e.g., a microprocessor, a gateway, a product link device, a communication adapter, etc.). Further, processor(s) 26 may execute software for performing one or more functions consistent with the disclosed embodiments. Processor(s) 26 may include any appropriate type of general purpose microprocessor, digital signal processor, or microcontroller.

Part database 30 may include data regarding critical packaging information associated with each customer-selectable component. For example, the data may include identification of a particular component (e.g., by name and/or by serial number), and a listing of dimensions that should be accommodated by the associated module to properly package the component within the module.

For example, with regard to FIG. 1, gas turbine engine 16 may have critical dimensions associated with a length, a width, a height, a weight, a location of mounting brackets, a location of air inlet ducts, a location of fuel inlet conduits, a location of exhaust outlets, a required size of ducts, conduits, outlets, etc. Likewise, compressor 18 may also have similar critical dimensions associated with its length, its width, its height, its weight, its location of mounting brackets, its location of gas inlet ducts, its location of gas discharge ducts, sizes of the associated ducts, etc. Accordingly, part database 30 may include an identification of a particular gas turbine engine 16, along with a listing of the dimensions critical to that particular gas turbine engine 16. Similarly, part database 30 may also include an identification at a particular compressor 18, along with a listing of the dimensions critical to that particular compressor 18. In the disclosed example, part database 30 includes families of multiple different gas turbine engines 16, along with listings of each of the dimensions critical to each different gas turbine engine 16 in each family. Likewise, part database 30 includes families of different compressors 18, along with listings of each of the dimensions critical to each of the different compressors 18 in each family.

For the purposes of this disclosure, a critical dimension may be considered a dimension that is unique to a particular component and/or family of components that has a direct affect on mounting, packaging, routing, and/or supporting of the component and/or assembly that receives the component. For example, when a configuration of mounting brackets of one gas turbine engine 16 is different from the configuration of mounting brackets of another turbine engine, a spacing, size, and/or number of mounting holes within platform 20 that are configured to receive the mounting brackets must also change in order to receive each of the particular engines 16. Accordingly, the spacing, size, and/or number of the mounting brackets may be considered critical dimensions of gas turbine engine 16.

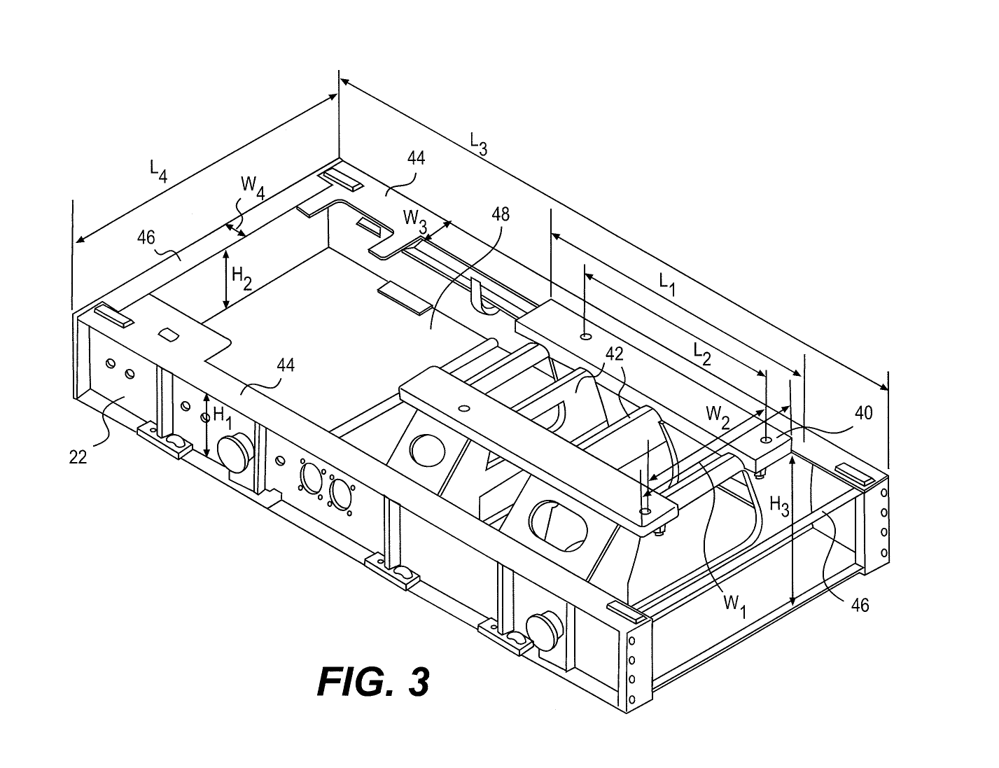

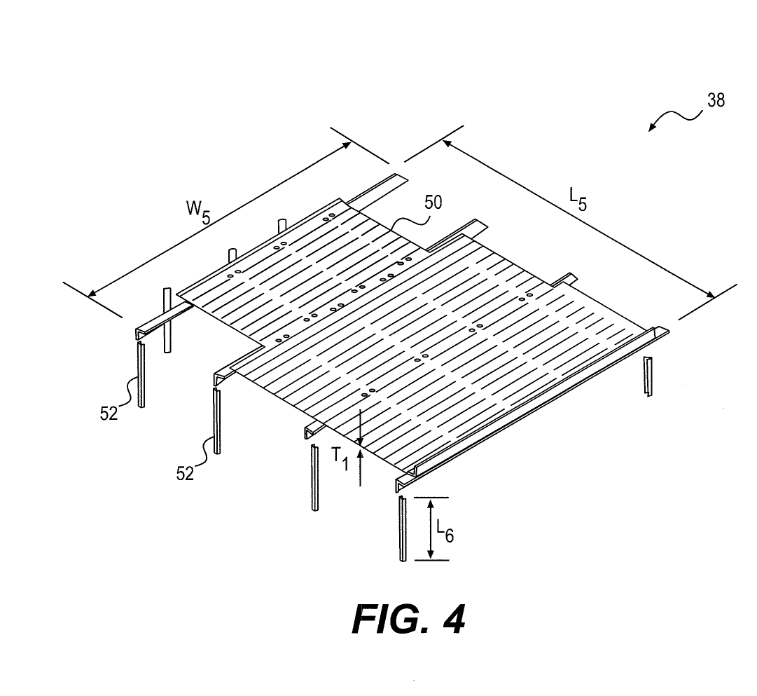

Part database 30 may also contain information relating to the support components in each of the gas turbine and compressor modules. For example, part database 30 may include data associated with fixed feature dimensions and variable feature dimensions for each non-selectable component of the gas turbine and compressor modules. As shown in FIGS. 3-5, the components may include, among others, fluid circuitry 36 (referring to FIG. 3) that facilitates fluid (e.g., lubricant, coolant, air, fuel, etc.) flow to and from engine 16 and/or compressor 18; a grating group 38 (referring to FIG. 4) that provides a working stage on platforms 20, 22; subcomponents of platforms 20 and 22; and pedestals 40 used to mount engine 16 and/or compressor 18 to platforms 20, 22. The fixed feature dimensions may be dimensions that remain substantially the same regardless of the particular configuration selected by the customer. The variable feature dimensions, however, are dimensions that can change to accommodate different configurations of machine 10.

FIGS. 3-5 illustrate exemplary components of machine 10 that may need to change in some manner to accommodate different configurations selected by a customer. In particular, FIG. 3 shows one embodiment of platform 22 having a first embodiment of pedestal 40. Depending on the particular engine 16 selected by the customer, pedestal 40 may need to change to properly accommodate mounting of compressor 18. For example, a length L₁ of pedestal 40 may need to stretch or shrink depending on the corresponding length of compressor 18 selected by the customer. Similarly, a width W₁ may need to stretch or shrink for the same reason. A length L₂ and a width W₂ may also or alternatively need to change to accommodate differences in mounting bracket sizes and/or locations associated with the selected engine 16 and/or compressor 18. Similarly, a height H3 of pedestal 40 may need to stretch or shrink depending on the corresponding heights of engine 16 and compressor 18 selected by the customer. Additionally or alternatively, as the overall dimensions of pedestal 40 change to accommodate one particular compressor 18, a number of supports 42 of pedestal 40 may need to increase or decrease. In like manner, platform 22 may need to increase a length L₃, width W₃, and/or height H₁ of side beams 44 and/or a length L₄, width W₄, and/or height H₂ of end beams 46 that form portions of platform 22. With these changes, corresponding changes to a base plate 48 may also be needed. Similar or additional changes may be necessitated within platform 20 based on the selection of a particular engine module. For example, in order to properly position the selected compressor 18 within the compressor module (e.g., axially, vertically, and/or transversely) relative to a selected engine 15 mounted within the selected gas turbine module, changes to the support components of the gas turbine module and/or the support components of the compressor module may be required.

FIG. 4 illustrates an exemplary grating group 38 having features that may need to be changed to accommodate a particular engine 16 and/or a particular compressor 18 that has been selected by a customer for packaging with machine 10. Specifically, grating group 38 may have components that cooperate to support an operator on top of platform 22. This support structure may need to avoid conflict with other components of machine 10, while still providing the required support. Accordingly, grating group 38 may have a size and/or shape that needs to vary based on the selected engine 16 and/or compressor 18. For example, grating group 38 may include framework components (e.g., metal bars, metal screens, perforated plates, etc.) 50, and a plurality of upright supports 52 that connect framework components 50 to platform 22. As a footprint of a selected engine 16 varies, the general outline of framework components 50 may likewise change, a length L₅ may change, a width W₅ may change, and/or a thickness T₁ may change. Similarly, a length L₆ of supports 52 and/or a number of supports 52 may change as framework components 50 change.

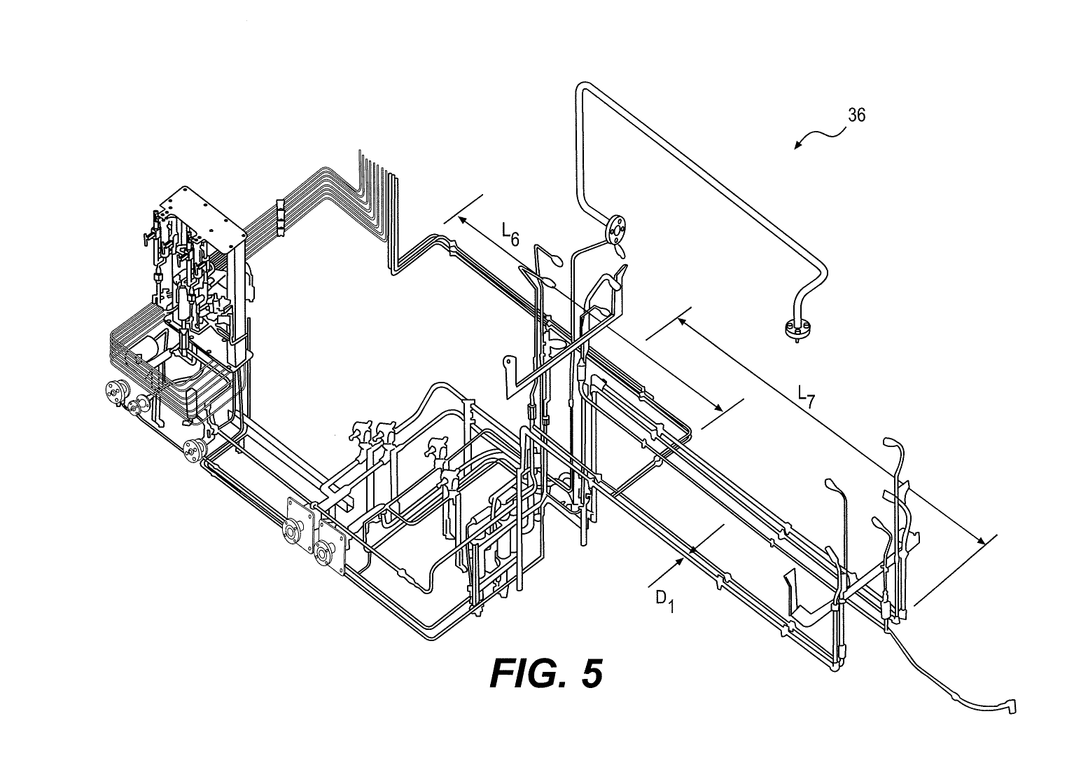

FIG. 5 illustrates an exemplary embodiment of fluid circuits 36 having features that may need to be changed to accommodate a particular engine 16 and/or a particular compressor 18 that has been selected by a customer for packaging with machine 10. Specifically, fluid circuits 36 may have components that cooperate to transport fluids between different locations on machine 10, such as between different ports (supply, return, test, relief, etc.) of engine 16 and offboard components (e.g., supply tanks, pumps, accumulators, etc.), between different portions of compressor 18 and other offboard components, and/or between engine 16 and compressor 18. For this reason, as different engines 16 and/or compressors 18 may have ports in different locations (e.g., further apart, closer together, higher, and/or lower), the fluid circuits 36 that connect these different ports together may need to change some for different combinations of engines 16 and/or compressors 18. While the individual components of fluid circuits 36 may retain some of their original shapes, other dimensions of these components may vary. For example, particular passages may have a length L₆ that increases or decreases, while other passages may have a length L₇ that increases or decreases. Similarly, the same or different passages may have a diameter D₁ that increases or decreases to accommodate different flow rates, pressures, or fluids associated with different selected engines 16 and/or compressors 18. It may also be possible that additional or different types of passages may be required for different configurations of engines 16 and/or compressors 18.

It should be noted that the support components listed above (e.g., platforms 20, 22; fluid circuitry 36, grating group 38, pedestals 40, etc.) are exemplary only. In particular, it may be possible for additional and/or different support components to be included within machine 10 and affected by customer selections of engine 16 and/or compressor 18, if desired. For example, driveshafts, gear boxes, wiring harnesses, pressure seals, and other components may need to change based on a particular selected configuration of machine 10.

In some embodiments, part database 30 may further contain information relating to modeling reference points associated with each fixed and/or each modifiable component within the gas turbine and/or compressor modules. For example, part database 30 may contain listings associated with each component that define a coordinate frame location and orientation, a required number and placement of reference datum planes and axis, directional information, etc. This information, as will be described in more detail below, may aid in automated generation of module assemblies with a computer aided drafting environment.

Relationship database 32 may include data regarding how the critical packaging information associated with each customer-selectable component relates to critical packaging information associated with other components (both customer selectable and non-selectable support components) in the same machine 10. In particular, relationship database 32 may contain a listing of components that must be modified in some way based on a particular component or module selection made by the customer. For example, for a given selection of a fourth engine 16 within a first family of available engines, relationship database 32 may have a listing of fifteen other components that must change in order to accommodate packaging of the selected engine 16. Likewise, for a selected combination of gas turbine module and compressor module (or engine 16 and compressor 18), relationship database 32 may have a listing of fifty other support components associated with both modules that must be changed in order to generate the machine design.

Further, relationship database 32 may contain tables, formulas, equations, algorithms, etc. regarding how the critical dimensions of selectable components affect dimensions of the other components contained within the listings. For example, for a selection of the fourth engine 16 within the first family of available engines described above, relationship database 32 may indicate how each of the other components must stretch, shrink, rotate, move, etc. based on the particular selection. In particular, for the engine selection described above and with a corresponding critical engine length and width listed in part database 30, a new platform 20 may need to be created having side and end beams 44, 46 that increase in length from base lengths L₃, L₄ (respectively—referring to FIG. 3) to new lengths (L₃+f(selected engine length)) and (L₄+f(selected engine width). Similarly, one or more new conduits within fluid circuits 36 may need to be created to accommodate the change in length of the new platform 20, for example to have a new length of (L6+f(L3+f(selected engine length))). Other similar relationships may be contained within relationship database 32.

Relationship database 32, in some embodiments, may further contain information relating the location and/or orientation of one component relative to another within a module assembly. For example, the information may relate the coordinate axis described above that are associated with a particular engine 16 selected by the customer with the coordinate axis of a particular conduit within fluid circuitry 36 that has been modified to match the selected engine 16. As will be described in more detail below, this information may aid the assembly of gas turbine and/or compressor modules within the computer aided drafting environment.

It should be noted that a different number and/or different types of databases may be included within system 24, if desired. For example, part database 30 and relationship database 32 may be broken into multiple different databases or, alternatively, combined within a single database. It is further contemplated that the information described above as being stored in the different databases may additionally or alternatively be stored within the memory of processor(s) 26 or elsewhere on network 28, if desired.

Processor(s) 26 may be configured to receive module and/or component selections from a customer or other user of system 24, e.g. by way of a graphics user interface (GUI) associated with display 34 and/or one or more input devices 58, and automatically generate new designs of machine 10. In particular, processor(s) 26 may be configured to retrieve critical dimensions from part database 30 associated with the selected modules and/or components, and relationship information for the other components within the same module(s) from relationship database 32. Processor(s) 26 may then determine if designs for the other components already exist and, when they do not exist, generate new designs based on the critical dimensions and relationship information.

In some embodiments, new design generation may include solid modeling of the individual components and assembly of the components into the associated modules within the computer aided drafting environment described above. Processor(s) 26 may further be configured to store data relating to the new component and/or assembly designs under unique identifiers, create manufacturing and/or assembly drawings based on the new designs, analyze the new designs for performance, stress, strain, longevity, or another predefined criteria, and/or automatically control manufacturing or assembly equipment to produce and/or test the new components.

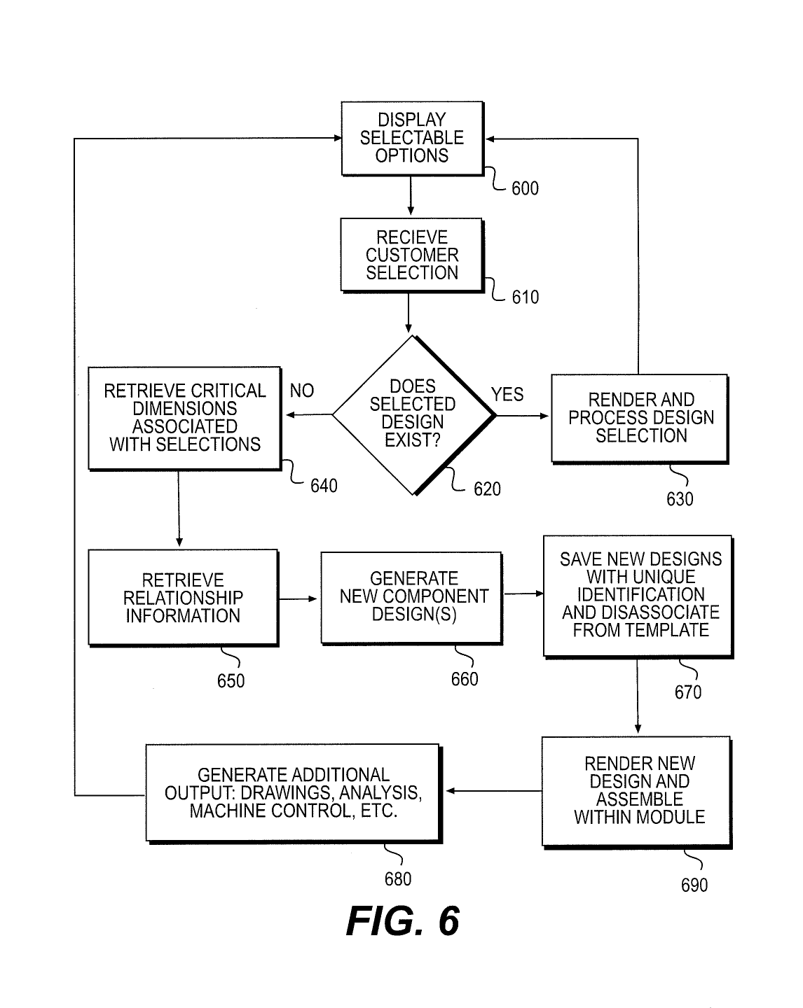

FIG. 6 illustrates an exemplary automated design process that may be performed by system 24. FIG. 6 will be described in more detail below to further illustrate the disclosed concepts.

### INDUSTRIAL APPLICABILITY

The components described above may constitute system 24 for automatically designing new components and assemblies of machine 10 based on customer component selections. The automated design process may be used to generate new configurations of machine 10 with reduced man hours and associated cost. Operation of system 24 will now be described in detail with reference to FIG. 6.

In an exemplary embodiment, processor(s) 26 may cause customer selectable options to be shown on display 34 (Step 600). The options may be displayed in the form of drop down menus that list the different families of engines 16 and/or compressors 18, among other things. From this GUI, the customer may select a specific combination of components for assembly in machine 10, and processor(s) 26 may receive this selection (Step 610).

Based on the combination of components selected by the customer, processor(s) 26 may determine if the selected design of machine 10 already exists (Step 620). If the selected design does exist (Step 620:Yes), processor(s) 26 may render the existing design (Step 630), and control may return to step 600. It is contemplated that other or additional control options may be available to the customer or user of system 24 at step 630, if desired. For example, the customer or user may be able to print the rendered design, pull up associated manufacturing and/or assembly drawings, generate a variety of different component and/or assembly analysis, etc.

When, however, at step 620, processor(s) 26 determines that the combination of components selected by the customer or user of system 24 does not currently exist (Step 620: No), processor(s) 26 may retrieve critical dimensions associated with the selection. In particular, processor(s) 26 may communicate with part database 30 to obtain a list of critical dimensions associated with the selected components (Step 640). In some embodiments, processor(s) 26 may also communicate with part database 30 to obtain modeling information associated with the selected components.

Following step 640, processor(s) 26 may obtain relationship information associated with the selected components (Step 650). As described above, this information may include a listing of other components affected by the customer's selection and information relating how these components may be affected (e.g., how particular dimensions of a support component may be affected by a change to a particular dimension in a customer selected component).

After receiving information from part database 30 and relationship database 32, processor(s) 26 may generate new designs for each of the components affected by the customer's selection, as well as new assembly designs for the corresponding gas turbine and/or compressor modules (Step 660). Generation of the new designs may include retrieving a generic template for each affected component from within a computer aided drafting environment, selecting particular dimensions of the template, and modifying those dimensions. The newly modified design may then be disassociated from the generic template, assigned a unique identifier, and saved within part database 30 (Step 670). Processor(s) 26 may then render the new component(s) within the computer aided drafting environment, and assembly the component(s) within the appropriate module and/or machine 10 based the coordinate frame location and orientation, required number and placement of reference datum planes and axis, directional information, etc. stored in relationship database 32. In some embodiments, processor(s) 26 may again assign a unique identifier to the completed assembly, and save the assembly within part database 30.

After component and/or assembly generation, processor(s) 26 may be further configured to automatically generate additional output (Step 680), before returning to step 600. This output may include, among other things, generation of manufacturing and/or assembly drawings based on the newly generated designs, analysis of the rendered models, automated machine control to produce and/or other assembly the components, and other output known in the art.

It will be apparent to those skilled in the art that various modifications and variations can be made to the methods and systems described above. Other embodiments will be apparent to those skilled in the art from consideration of the specification and practice of the disclosed methods and systems. It is intended that the specification and examples be considered as exemplary only, with a true scope being indicated by the following claims and their equivalents.

What is claimed is:

1. An automated machine design system, comprising:
at least one of a part database and a relationship database;
a display device;
an input device; and
one or more processors in communication with the at least one of a part database and a relationship database, the display device, and the input device, the one or more processors being configured to:
cause a listing of components selectable by a customer for inclusion within a machine to be shown on the display device;
receive a selection of the components from the listing by the customer via the input device;
retrieve data regarding selected components from the at least one of the part database and the relationship database; and
generate a design for at least one new support component in the machine based on the selected components and the data.

2. The automated machine design system of claim 1, wherein the listing of components includes a first listing of available input components and a second listing of available output components.

3. The automated machine design system of claim 2, wherein:
the available input components include different gas turbine engines; and
the available output components include different compressors connectable to be driven by the gas turbine engines.

4. The automated machine design system of claim 3, wherein the at least one new support component includes at least one of a platform beam, a pedestal, a grating group, and fluid circuitry.

5. The automated machine design system of claim 1, wherein the data regarding selected components includes a listing of critical dimensions that vary between different components of the listing of components selectable by the customer.

6. The automated machine design system of claim 5, wherein the data regarding selected components further includes relationship information regarding how the at least one new support component should change based on the listing of critical dimensions.

7. The automated machine design system of claim 6, wherein the data regarding selected components further includes computer aided drafting data associated with at least one of a coordinate frame location and orientation, a required number and placement of reference datum planes and axis, and directional information for the at least one of the selected components and the at least one new support component.

8. The automated machine design system of claim 1, wherein the one or more processors is further configured to render the design for the at least one new support component within a computer aided drafting environment.

9. The automated machine design system of claim 8, wherein the one or more processors is further configured to:
disassociate the design for the at least one new support component from a generic template used to generate the design;
assign a unique identifier to the design; and
save the design within the at least one of the part database and the relationship database.

10. The automated machine design system of claim 9, wherein the one or more processors is further configured to assemble the selected component and the at least one new support component within the computer aided drafting environment.

11. The automated machine design system of claim 10, wherein the one or more processors is further configured to generate at least one of a drawing and an analysis of the at least one new support component after the design is complete.

12. A method for automatically designing a machine, comprising:
displaying a listing of components selectable by a customer for inclusion within a machine;
receiving a selection of the components from the listing by the customer;
retrieving data regarding selected components from at least one of a part database and a relationship database; and
automatically generating a design for at least one new support component in the machine based on the selected components and the data.

13. The method of claim 12, wherein the listing of components includes a first listing of available input components and a second listing of available output components.

14. The method of claim 13, wherein:
the available input components include different gas turbine engines; and
the available output components include different compressors connectable to be driven by the gas turbine engines.

15. The method of claim 14, wherein the at least one new support component includes at least one of a platform beam, a pedestal, a grating group, and fluid circuitry.

16. The method of claim 12, wherein the data regarding selected components includes a listing of critical dimensions that vary between different components of the listing of components selectable by the customer.

17. The method of claim 16, wherein the data regarding selected components further includes relationship information regarding how the at least one new support component should change based on the listing of critical dimensions.

18. The method of claim 17, wherein the data regarding selected components further includes computer aided drafting data associated with at least one of a coordinate frame location and orientation, a required number and placement of reference datum planes and axis, and directional information for the at least one of the selected components and the at least one new support component.

19. The method of claim 12, further including rendering the design for the at least one new support component within a computer aided drafting environment.

20. The method of claim 19, further including:
disassociating the design for the at least one new support component from a generic template used to generate the design;
assigning a unique identifier to the design; and
saving the design within the at least one of the part database and the relationship database.

21. The method of claim 20, further including assembling the selected component and the at least one new support component within the computer aided drafting environment.

22. The method of claim 22, further including generating at least one of a drawing and an analysis of the at least one new support component after the design is complete.

23. The new support component having a design automatically generated using the method of claim 12.

24. The machine automatically designed using the method of claim 23, the machine being an assembly including the new support component.

25. A non-transitory computer readable medium for use on at least one computer system containing computer-executable programming instructions for performing a method of automated machine design, the method comprising:
displaying a listing of components selectable by a customer for inclusion within a machine;
receiving a selection of the components from the listing by the customer;
retrieving a listing of critical dimensions that vary between different components of the listing of components selectable by the customer;
retrieving relationship information regarding how the at least one new support component should change based on the listing of critical dimensions;
automatically generating a design for at least one new support component in the machine based on the selected components, the critical dimensions, and the relationship information;
disassociating the design for the at least one new support component from a generic template used to generate the design;
assigning a unique identifier to the design;
saving the design; and
rendering the design for the at least one new support component within a computer aided drafting environment.

26. The non-transitory computer readable medium of claim 25, wherein:
the listing of components includes a first listing of available gas turbine engines and a second listing of available compressors connectable to be driven by the gas turbine engines; and
the at least one new support component includes at least one of a platform beam, a pedestal, a grating group, and fluid circuitry.

27. The non-transitory computer readable medium of claim 25, further including retrieving computer aided drafting data associated with at least one of a coordinate frame location and orientation, a required number and placement of reference datum planes and axis, and directional information for the at least one of the selected components and the at least one new support component.
